(19) United States
(12) Patent Application Publication
(10) Pub. No.: US 2024/0394172 A1
(43) Pub. Date: Nov. 28, 2024

(54) METHODS AND APPARATUS FOR INFERRING FUNCTION SYMBOL NAMES FROM ASSEMBLY CODE IN AN EXECUTABLE BINARY WITH TRANSFORMER-BASED ARCHITECTURE, AND RECORDING MEDIUM

(71) Applicant: Research & Business Foundation Sungkyunkwan University, Suwon-si (KR)

(72) Inventors: Hyungjoon KOO, Suwon-si (KR); Hyunjin KIM, Suwon-si (KR); Jinyeong BAK, Suwon-si (KR)

(73) Assignee: Research & Business Foundation Sungkyunkwan University, Suwon-si (KR)

(21) Appl. No.: 18/674,646

(22) Filed: May 24, 2024

(30) Foreign Application Priority Data
May 25, 2023 (KR) 10-2023-0067351

(51) Int. Cl. G06F 11/36; G06N 5/04

(52) U.S. Cl. CPC G06F 11/3624; G06N 5/04

(57) ABSTRACT

Disclosed is a method inferring function symbol names from assembly code in an executable binary with transformer-based architecture on a computing apparatus having at least one processor. The method includes: performing BPE (Byte-Pair-Encoding) tokenization on the assembly code, without code normalization for using the assembly code as an input to the inference model; and inferring the function symbols based on the input. The inference model performs operations as follows: at each layer of an encoder and decoder, normalizing input tokens by grouping similar tokens in an input vector and then dividing each group by a sum of unique values, and applying positional embedding at each layer of the encoder.

### CROSS REFERENCE TO RELATED APPLICATION

This application claims priority from Republic of Korea Patent Application No. 10-2023-0067351, filed on 25 May 2023, which is hereby incorporated by reference in its entirety.

### BACKGROUND

### Field

The present disclosure relates to a reverse-engineering technique for analyzing an executable file (binary), and more specifically to a method and apparatus for inferring a function symbol in debugging information based on artificial intelligence.

### Related Art

When software development is completed, unlike the source code, many function symbols such as variable names, types, function names, and structures are lost during the compilation stage, leaving the executable binary deployed in a state where these details are missing. This necessitates the analysis of the binary's behavior through assembly (machine code) itself in various situations such as malware analysis and code duplication detection, which is a process known as reverse engineering.

However, understanding the context from a stripped executable binary, where debugging information is absent, is extremely difficult. Also, recovering lost information from the compilation stage poses limitations with traditional analysis techniques, be it static or dynamic binary analysis.

In other words, conventional methods for binary reverse engineering often employ assembly code inference techniques, where the assembly code is normalized in various ways to serve as input to the model. For instance, the DeepBinDiff normalization technique splits machine language into opcodes and operands. The DeepSemantic technique addresses the out-of-vocabulary (OOV) issue where the model encounters words has never been seen before training, by replacing immediate, register, and pointer values with specific tokens.

In addition, NERO utilizes control flow graph information within the binary as input. However, relying solely on call information extracted from the disassembled entire assembly code does not yield high performance.

The above-described code normalization technique commonly relies on selectively utilizing specific code information by humans. However, since such a code normalization technique manipulates potentially useful information within an assembly code arbitrarily to input the information, this may ultimately lead to performance degradation.

### SUMMARY

Inference of a function symbol in an assembly code within an executable binary is equivalent to recovering information already lost at a compilation stage, so it is irreversible using existing methods. In other words, since it is impossible to infer a function symbol using the existing analysis methods such as static or dynamic binary analysis technology, the present disclosure aims to infer a function name through a transformer-based dedicated inference model.

In one aspect, there is provided a method for inferring a function symbol from an assembly code using a transformer-based function symbol inference model on a computing apparatus having at least one processor. The method includes: performing BPE (Byte-Pair-Encoding) tokenization on the assembly code, without code normalization for using the assembly code as an input to the inference model; and inferring the function symbols based on the input. The inference model performs operations as follows: at each layer of an encoder and decoder, normalizing input tokens by grouping similar tokens in an input vector and then dividing each group by a sum of unique values, and applying positional embedding at each layer of the encoder.

Each of the encoder and decoder has two to four layers.

In the inferring of the function symbols based on the input, (A) when fetching assembly code embedding and the positional embedding, the encoder may calculate an attention value within an assembly sequence and transmits the attention value to the decoder, and (B) the decoder may calculate an attention value using both token embedding of the decoder and token embedding of the encoder-decoder. (A) and (B) may be repeatedly performed until the inference model infers [EOS].

In (B), the decoder may not apply the positional embedding when calculating the attention value.

Each of the encoder and decoder may have three layers, and the function symbol may be a function name lost during a compilation process.

In another aspects, there are provided an apparatus implementing the above-described method, and a recording medium on which a program is recorded.

Through the present disclosure, by inferring the function symbol name using a function name generation model trained with deep learning, it is possible to recover a significant portion of lost information (i.e., original function name), which was previously impossible to retrieve with existing static/dynamic analysis. If the function symbol name can be inferred through a function name generation model named by a programmer to well describe a function behavior, it is possible to greatly reduce the time and effort required to analyze binary information. Typically, even a skilled reverse engineering engineer spends several minutes analyzing a single binary function, and overall binary code behavior analysis takes a considerable amount of time. However, in the case of the present disclosure, experimentally, about 100 functions may be inferred within about 30 ms using a single A6000 GPU.

### BRIEF DESCRIPTION OF THE DRAWINGS

FIG. 1 shows the architecture of a transformer-based function symbol inference model composed of an encoder and a decoder according to the present disclosure.

FIG. 2 shows how position information is added to each encoder layer.

FIG. 3 shows the results of an experiment conducted to compare the performance of Per-Layer Positional Embedding.

FIG. 4 shows an example of the Unique-softmax function.

FIG. 5 describes the pseudo-code of Unique-softmax.

FIG. 6 shows the results of an experiment conducted to compare the performance of Unique-softmax.

FIG. 7 shows the results of an experiment conducted to compare the performance of a model according to the present disclosure.

FIG. 8 shows the results of function name inference using a code normalization technique.

FIG. 9 shows the results of comparing the size of parameters and vocabulary according to different tokenization methods in different sizes of data sets.

FIG. 10 is a flowchart explaining a method for inferring a function symbol in assembly code according to the present disclosure.

FIG. 11 is a block diagram showing a computing apparatus for inferring a function symbol from assembly code.

### DESCRIPTION OF EXEMPLARY EMBODIMENTS

Hereinafter, embodiments of the present disclosure will be described in detail with reference to the drawings. In describing the present disclosure, if it is determined that a detailed description of known functions and structures associated with the present disclosure unnecessarily obscure the gist of the present disclosure, the detailed description thereof will be omitted. When a part is referred to as “including” a component, other components are not excluded therefrom and may be further included unless specified otherwise.

The terms “first,” “second,” etc. are used to distinguish one component from other components, and components are not limited by the terms. These terms are only used to distinguish one element from another. For example, unless the context indicates otherwise, a first element could be termed a second element, and, similarly, a second element could be termed a first element, without departing from the scope of the present inventive concept.

The terms and expressions used in the present disclosure are used only for the purpose of illustrating particular embodiments, and are not intended to limit the present disclosure. Unless stated otherwise, an expression of singularity is intended to include expressions of plurality. It should be noted that the terms “include” or “have” as used in the present disclosure are intended to denote the existence of any features, numerical values, steps, operations, constituent elements, parts, and combinations thereof described in the specification, but are not intended to preliminarily exclude the possibility of existence or addition of any one or more other features, numerical values, steps, operations, constituent elements, parts, and combinations thereof.

Unless otherwise defined, all terms (including technical and scientific terms) used herein have the same meaning as commonly understood by one of ordinary skill in the art to which the present disclosure's concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A function symbol inference model according to the present disclosure, based on a well-known artificial intelligence transformer, infers function symbols, i.e. function symbols such as variable names, types, function names, structures, etc., which are lost during the compilation phase. Preferably, the function symbol inference model infers a function name among the function symbols, but the present disclosure is not necessarily limited to the function name.

The inventor of the present disclosure failed to train a model constructed based on a well-known general-purpose transformer (by using a dataset pre-processed with a commonly used normalization technique). This failure was analyzed to stem from the relationship between assembly codes becoming blurred in the higher layers of the transformer. For instance, if 64-bit registers (e.g., rax, rcx, r9) are replaced with symbols representing 64-bit registers (e.g., reg8) resulted in generating the same consecutive words (e.g., pop reg8, pop reg8) in a function prologue or epilogue.

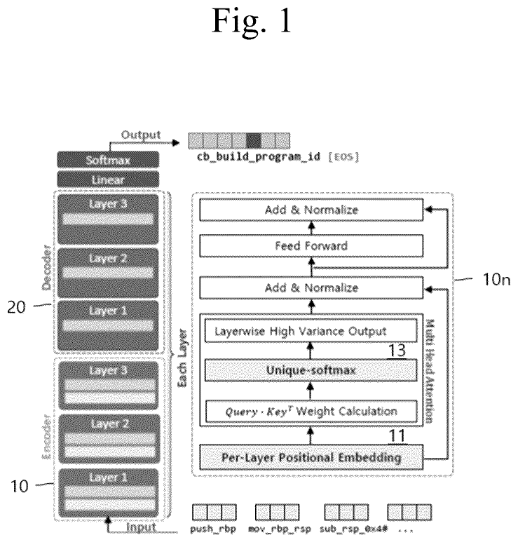

Accordingly, the function symbol inference model of the present disclosure is constructed based on a transformer, but has an architecture as shown in FIG. 1 to improve the above-mentioned problems.

FIG. 1 shows the architecture of a transformer-based function symbol inference model composed of an encoder and a decoder according to the present disclosure.

The function symbol inference model according to the present disclosure includes an encoder 10 and a decoder 20 with a reduced number of layers. FIG. 1 illustrates that the number of layers in each of the encoder and decoder is reduced to 3, compared to six layers in each of the existing encoder and decoder. The number of layers in the encoder and decoder is preferably 2 to 4, and most preferably 3.

An encoder 20n in each layer further includes Per-Layer Positional Embedding 11 and Unique-softmax Function 13 to address the problem. This will be explained in detail in the following.

### Per-Layer Positional Embedding

Humans understand the meaning of a sentence even when the words are scrambled. The order of assembly codes (e.g., the topological order in a control flow graph) are crucial in accurately performing a desired task.

Therefore, to enable the model to better comprehend a sequence of machine instructions, high-quality positional information must be provided. To this end, the present disclosure employs absolute positional embedding of BERT, instead of the sinusoidal positional encoding of the vanilla Transformer.

Unlike BERT, which applies positional embedding only before the first layer of the encoder, the model of the present disclosure introduces Per-Layer Positional Embedding. This ensures that a positional representation is provided at each layer of the encoder, preventing the loss of positional information in higher layers.

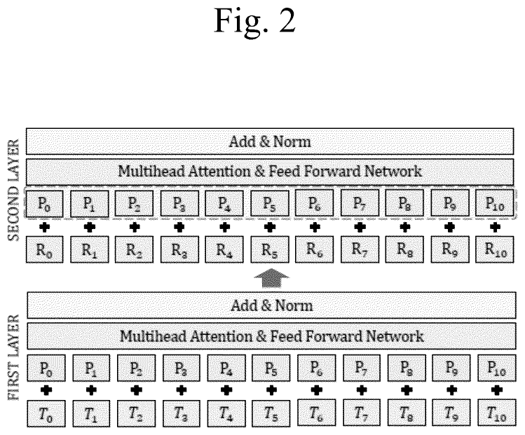

FIG. 2 shows how position information is added to each encoder layer. Position information is not included because a transformer may learn the position information during a decoding stage (i.e. masking effect).

In FIG. 2, unlike the vanilla transformer, which applies positional embedding (P) only at the first layer, the present disclosure additionally provides positional embedding (dashed area) to every higher layer. Here, P, T and R represent the position, token, and (internal) representation encoding, respectively.

Although only two layers are shown in FIG. 2, positional embedding is actually applied to every layer of the transformer to prevent position information from disappearing from higher layers.

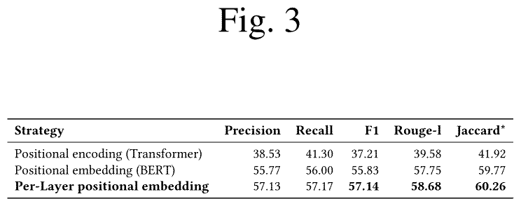

Meanwhile, FIG. 3 shows the results of an experiment conducted to compare the performance of Per-Layer Positional Embedding. According to the experimental results, Per-Layer Positional Embedding exhibits superior performance compared to other position information learning techniques.

Meanwhile, the present disclosure utilizes the Jaccard score to evaluate the performance of the model. The Jaccard score will be described below.

### Jaccard Score

One widely adopted metric for evaluating language generation models is the bilingual evaluation understudy (BLEU) score. Directly applying the BLEU to a short output (e.g., the average token length of a function name is about 3) is inappropriate due to excessive brevity penalty within a short token sequence.

On the other hand, a function symbol has a short output, so understanding the original meaning from an inferred function symbol without considering the order may be straightforward due to the concise output.

To this end, the model of the present disclosure was evaluated through an order-agnostic Jaccard score, which can effectively evaluate short word sequences (e.g., function symbols). In particular, to prevent the generation of a superset of ground truth, a negative brevity penalty (NBP) is utilized, which starts penalizing when the number of inferred words exceeds the number of reference words.

Equation 3 below briefly illustrates the Jaccard score customized for evaluating a short output generation task. Here, H and R represent a set of inferred words and a set of reference words (i.e., ground truth), respectively.

$$Jaccard * score = NBP \times \frac{\vert R ⋂ H \vert}{\vert R \vert} where \qquad [ Equation 3 ]$$

$$NBP = \{ \begin{matrix}1 & if \vert H \vert \leq \vert R \vert \\ exp ( 1 - \frac{\vert H \vert}{\vert R \vert} ) & otherwise\end{matrix}$$

### Unique-Softmax Function

One of the common characteristics of Natural Language Processing (NLP) is the frequent occurrence of stop words, such as articles (“a”, “the”, “of”), which convey little contextual meaning. While an activation function may include several machine instructions that deviate from the original context, such as nop operations (like 0x8D8E addresses), each machine instruction (e.g., push, mov) represents a valid operation.

The problem with this characteristic is that a probability value of a duplicate word appearing in the key may be distributed due to the use of softmax in the process of querying and keying to calculate attention, which represents the relationship between tokens.

The softmax function, which is an activation function included in the transformer, calculates an attention value between tokens by dividing the product of query and key vectors, as shown in Equation 1. In Equation 1, x is the input vector (i.e., the product of query and key vectors in the Transformer), and n is the size of a vector (i.e., the number of tokens).

$$softmax ( {x}_{i} ) = \frac{exp ( {x}_{i} )}{{\sum }_{j}^{n} exp ( {x}_{j} )} \qquad [ Equation 1 ]$$

Due to the layer normalization and scaling by the Softmax, some values are kept large and other values are kept very small, which limits understanding of the relationship (presentation) between tokens.

Furthermore, on the attention heatmap of each transformer layer, attention values between tokens dim toward higher layers.

In order to address this softmax's dimming, the present disclosure introduces the Unique-softmax function. As illustrated in Equation 2, the Unique-softmax function normalizes input tokens by grouping similar tokens in an input vector and then dividing each group by a sum of unique values. In Equation 2, u is the vector with a unique value from x, and d is the size of the vector u.

$$softmax ( {x}_{i} ) = \frac{exp ( {x}_{i} )}{{\sum }_{j}^{n} exp ( {x}_{j} )} \qquad [ Equation 2 ]$$

The denominator of the Unique-softmax function is smaller than or equal to softmax's denominator because the same value is not added multiple times.

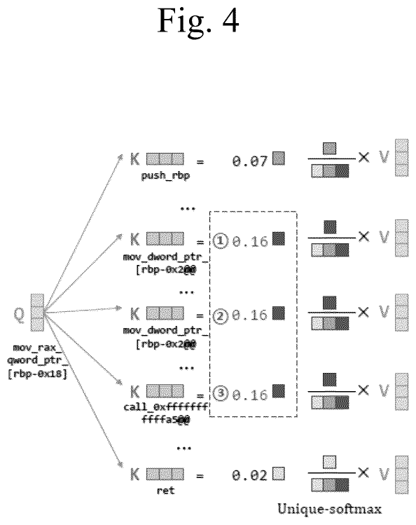

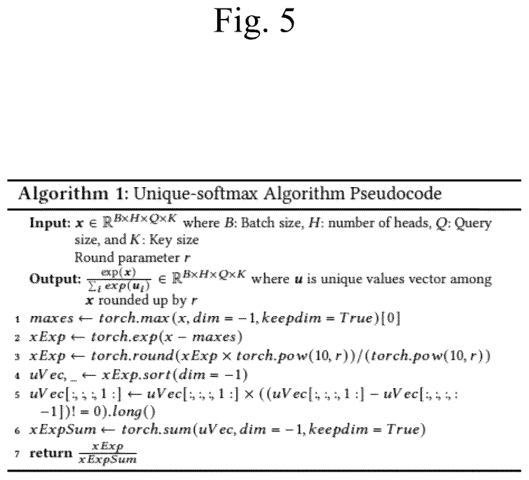

Therefore, the output of Unique-softmax is higher than softmax due to the following value d. To find similar values in a vector, the values are rounded to the parameter r. FIG. 4 illustrates an example of the Unique-softmax function, and FIG. 5 describes the pseudo-code of the Unique-softmax function.

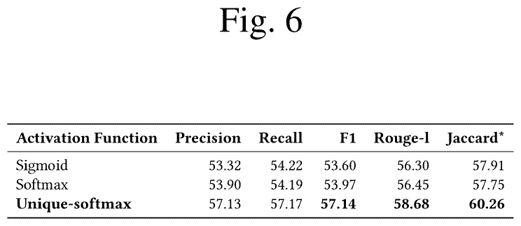

FIG. 6 shows the results of an experiment conducted to compare the performance of the Unique-softmax function. According to the experimental results, the Unique-softmax function exhibits superior performance compared to other activation functions.

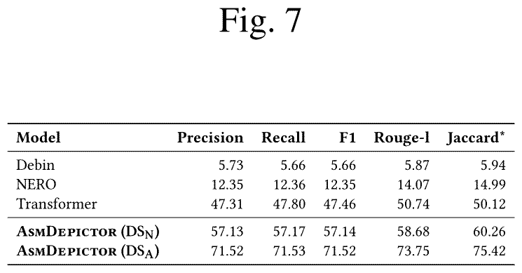

In addition, FIG. 7 shows the results of an experiment conducted to compare the performance of the model (AsmDepictor) based on the structure described. The experimental results show that the AsmDepictor model according to the present disclosure outperforms Debin and NERO by approximately four times. Furthermore, the AsmDepictor model trained with DS_{A} has achieved a maximum of 71.5 F1 and 75.4 Jaccard scores.

Hereinafter, the preprocessing of the data input to the model as described above will be described.

A set of assembly code (i.e., machine instructions,) contained in a function provides precise descriptions of a specific task executed by a processor. While learning assembly directly can offer rich information for model construction, vectorizing each assembly code requires too many computation resources due to the sheer number of instructions and poses challenges for meaningful embedding due to Out-Of-Vocabulary (OOV) and sparse instructions.

That is, unlike generating a translation model in NLP, an input vocabulary set of assembly codes contains not only sparse words but also a vast number of words.

In an assembly code, the operand of an instruction such as call or jmp represents the absolute address or relative offset of a destination to call the function or jump thereto. Likewise, immediate values include constants that are loaded into a memory or register to perform arithmetic/logical operations. Considering the vast number of immediate values (i.e., about 4 billion for 4 bytes) and operands, tokenizing every word incurs significant costs and poses difficulties due to OOV issues (i.e., impossible to train all words in advance) and rare occurrences of sparse instructions (i.e., insufficient frequency for meaningful embedding).

Therefore, it is necessary to convert an assembly code into a format (token) suitable for model training, while maintaining a balance between retaining rich information contained in the assembly code and actually addressing both sparse words and OOV issues.

In addition, the presence of a duplicate function body disrupts model training, so this should also be taken into account (e.g., the model may be confused when encountering the same function body with different function symbols). The inventor of the present disclosure constructs a training data set which is refined by removing duplicate a function symbol and tokenizing each assembly code using Byte Pair Encoding (BPE).

In addition, to effectively import an assembly code into a neural network, three main vocabulary issues should be addressed: (1) total vocabulary size, (2) Out-Of-Vocabulary (OOV), and (3) sparse vocabulary.

Thus, converting an assembly code (machine instruction) into an appropriate data representation is essential as this conversion serves as the basis for internal data representation.

Several code normalization strategies proposed by Inner Eye, DeepSemantic, and PalmTree were adopted to quantitatively measure the effectiveness of code normalization. InnerEye has introduced several simple rules to prevent OOV in code representation by replacing immediate values, strings, function names, and labels (e.g., target addresses) with 0, <str>, <FOO>, and <tag>.

DeepBinDiff splits an instruction into opcodes and operands, while DeepSemantic proposes detailed normalization (e.g., well-balanced normalization) for operands (e.g., immediate, register, pointer). Similarly, PalmTree maintains 2-byte immediate constants to provide rich information.

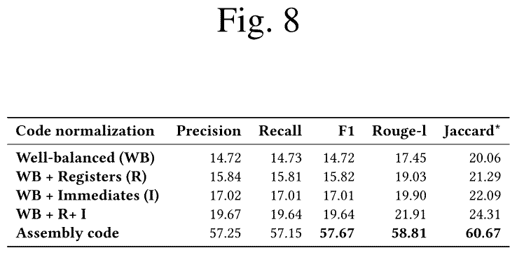

FIG. 8 shows the results of function name inference using a code normalization technique.

The inference results show that with Well-balanced basic approach having the least amount of information in the code, providing additional information actually helps the prediction task. Thus, in the present disclosure, input data maintains an assembly code intact, without code normalization.

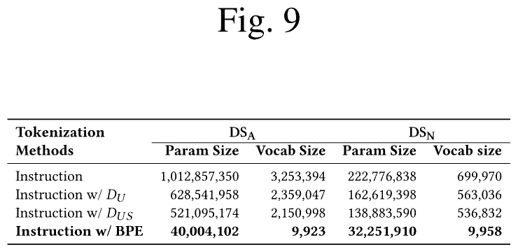

FIG. 9 shows the results of comparing the size of parameters and vocabulary according to different tokenization methods in different sizes of data sets. In the experiment, DS_{A} is 3,063 binary data, and DS_{N} is 541 binary data.

The experimental results reveal that the model's size (parameter size) increases with the vocabulary size. For DS_{A}, when the number of tokens is 3.25 million, the number of parameters exceeds 1 billion. However, in the case of BPE tokenization, the parameter size is approximately 40 M, and the vocabulary size is less than 10K, indicating that both the parameter size and vocabulary size are appropriate.

Therefore, based on these experiments, the present disclosure performs Byte-Pair Encoding (BPE) tokenization on input data, without code normalization.

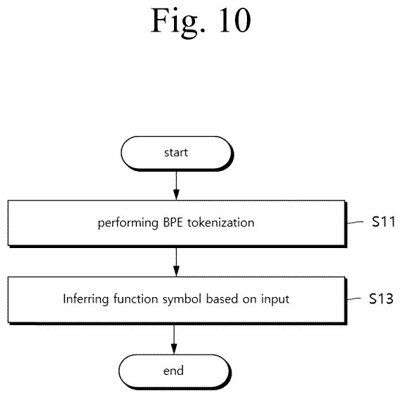

Hereinafter, a method for inferring a function symbol in assembly code will be described using the function symbol inference model described above with reference to FIG. 10. FIG. 10 is a flowchart explaining a method for inferring a function symbol in assembly code according to the present disclosure.

The method for inferring a function symbol from an assembly code according to the present disclosure includes operation S11 of performing Byte-Pair Encoding (BPE) tokenization on the assembly code, without code normalization for using the assembly code as an input to the inference model, and operation S13 of inferring the function symbol based on the input.

Here, the inference model is configured as described above, and each of the encoder and decoder has two to four layers. The inference model, at each layer, normalizes tokens by grouping similar tokens from an input vector and then dividing each group by a sum of unique values, and applies positional embedding to each layer of the encoder.

In addition, in operation S13, (A) when fetching assembly code embedding and the positional embedding, the encoder calculates an attention value within an assembly sequence and transmits the attention value to the decoder, and (B) the decoder calculates an attention value using both token embedding of the decoder and token embedding of the encoder-decoder. The processes (A) and (B) are repeatedly performed until the inference model infers [EOS].

In process (B), the decoder does not apply the positional embedding when calculating the attention value.

First, operation S11 is a process of refining an input. As described above, in the present disclosure, data input to the model is not normalized, but tokenized according to the BPE technique.

In operation S13, the model predicts the function symbol based on the input.

As shown in FIG. 1, when assembly code embedding and positional embedding 11 are imported from the model, (A) the encoder 10 calculates an attention value (i.e., relevance of the input) within an assembly sequence and transmits the attention value to the decoder 20.

Lastly, (B) the decoder uses both token embedding of the decoder and token embedding of the encoder-decoder (without applying current position information) to calculate attention values, predicts a word with the highest probability using the softmax layer, and uses beam search to output a predicted token. The processes (A) and (B) are repeatedly performed until the model predicts [EOS].

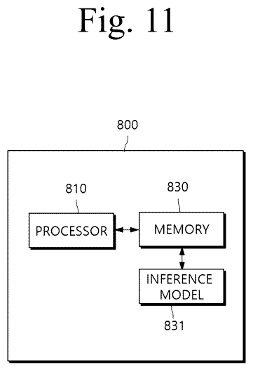

FIG. 11 is a block diagram showing a computing apparatus for inferring a function symbol from an assembly code, where a series of elements are reconfigured from a hardware configuration perspective. Therefore, to avoid redundancy in the explanation, only the overview of each element is briefly described, focusing on functions and operations of a corresponding element.

A computing apparatus 800 includes a memory 830 for storing a transformer-based function symbol inference model 831, and a processor 810 for executing the function symbol inference model 831 to infer a result from an input.

In the function symbol inference model 831, each of an encoder and a decoder has two to four layers. The inference model, at each layer, normalizes tokens by grouping similar tokens from an input vector and then dividing each group by a sum of unique values, and applies positional embedding to each layer of the encoder.

In addition, under the control of the processor 810, the function symbol inference model 831 performs the following: (A) when the encoder fetches assembly code embedding and positional embedding, the function symbol inference model 831 calculates an attention value within an assembly sequence and transmits the attention value to the decoder, and (B) the decoder calculates an attention value using both the decoder's token embedding and the encoder-decoder token embedding. The processes (A) and (B) are repeatedly performed until the inference model infers [EOS].

Meanwhile, the present disclosure may be implemented as computer readable codes on a computer-readable recording medium. The computer-readable recording medium may be any data storage device that may store data which may be thereafter read by a computer system.

Examples of the computer-readable recording medium include read only memory (ROM), random access memory (RAM), compact disk-read only memory (CD-ROM), magnetic tapes, floppy disks, optical data storage devices, etc. The computer-readable recording medium may also be distributed over network-coupled computer systems so that the computer-readable code may be stored and executed in a distributed fashion. Also, functional programs, codes, and code segments for accomplishing the present disclosure may be easily construed by programmers skilled in the art to which the inventive concept pertains.

In the above, various embodiments of the present disclosure has been shown and described. It will be understood by those of ordinary skill in the art that various changes in form and details may be made therein without departing from the spirit and scope according to the present disclosure. Therefore, it should be understood that the exemplary embodiments described herein should be considered in a descriptive sense only and not for purposes of limitation. Therefore, the scope of the present disclosure is defined not by the detailed description but by the following claims, and all differences within the scope will be construed as being included in the present disclosure.

What is claimed is:

1. A method for inferring function symbol names from assembly code in an executable binary with transformer-based architecture on a computing apparatus having at least one processor, the method comprising:
performing BPE (Byte-Pair-Encoding) tokenization on the assembly code, without code normalization for using the assembly code as an input to the inference model; and
inferring the function symbols based on the input,
wherein the inference model performs operations as follows:
at each layer of an encoder and decoder, normalizing input tokens by grouping similar tokens in an input vector and then dividing each group by a sum of unique values, and
applying positional embedding at each layer of the encoder.

2. The method of claim 1, wherein each of the encoder and decoder has two to four layers.

3. The method of claim 1, wherein in the inferring of the function symbols based on the input,
(A) when fetching assembly code embedding and the positional embedding, the encoder calculates an attention value within an assembly sequence and transmits the attention value to the decoder, and
(B) the decoder calculates an attention value using both token embedding of the decoder and token embedding of the encoder-decoder,
wherein (A) and (B) are repeatedly performed until the inference model infers [EOS].

4. The method of claim 3, wherein in (B), the decoder does not apply the positional embedding when calculating the attention value.

5. The method of claim 1, wherein each of the encoder and decoder has three layers.

6. The method of claim 1, wherein the function symbol is a function name lost during a compilation process.

7. A non-transitory computer readable recording medium storing instructions, when executed by one or more processors, configured to perform the method of claim 1.

8. A computing apparatus comprising:
a memory configured to store a transformer-based function symbol inference model; and
a processor configured to execute the function symbol inference model to infer a result from an input,
wherein the inference model performs operations as follows:
at each layer of an encoder and decoder, normalizing input tokens by grouping similar tokens in an input vector and then dividing each group by a sum of unique values, and
applying positional embedding at each layer of the encoder.

9. The computing apparatus of claim 8, wherein each of the encoder and decoder layers has two to four layers.

10. The computing apparatus of claim 8, wherein, under the control of the processor, the inference model performs operations as follows:
(A) when fetching assembly code embedding and the positional embedding, the encoder calculates an attention value within an assembly sequence and transmits the attention value to the decoder, and
(B) the decoder calculates an attention value using both token embedding of the decoder and token embedding of the encoder-decoder,
wherein (A) and (B) are repeatedly performed until the inference model infers [EOS],

11. The computing apparatus of claim 10, wherein in (B), the decoder does not apply the positional embedding when calculating the attention value.

12. The computing apparatus of claim 8, wherein each of the encoder and decoder has three layers.

13. The computing apparatus of claim 8, wherein the function symbol is a function name lost during the compilation process.
